(19) United States
(12) Patent Application Publication
(10) Pub. No.: US 2016/0231972 A1
(43) Pub. Date: Aug. 11, 2016

(54) DISPLAY DEVICE

(71) Applicant: SAMSUNG DISPLAY CO., LTD., Yongin-si (KR)

(72) Inventors: Jongsung You, Suwon-si (KR); Sanghoon Lim, Cheonan-si (KR); Kwanyoung Han, Seongnam-si (KR)

(21) Appl. No.: 15/013,788

(22) Filed: Feb. 2, 2016

(30) Foreign Application Priority Data
Feb. 6, 2015 (KR) 10-2015-0018640

(51) Int. Cl. G06F 3/147

(52) U.S. Cl. CPC G06F 3/147

(57) ABSTRACT

A display device capable of preventing or significantly reducing detachment between a window and a display panel at a high temperature includes: a display panel configured to display an image; a window on the display panel, the window including a display area through which the image is transmitted and a non-display area around the display area; and an adhesive layer between the display panel and the window. The window includes: a window substrate facing the display panel; a light blocking layer on a surface of the window substrate in the non-display area, the surface of the window substrate facing the display panel; and an auxiliary adhesive layer on the light blocking layer.

### CROSS-REFERENCE TO RELATED APPLICATION

This application claims priority to, and the benefit of, Korean Patent Application No. 10-2015-0018640, filed on Feb. 6, 2015, with the Korean Intellectual Property Office (“KIPO”), the disclosure of which is incorporated herein in its entirety by reference.

### BACKGROUND

1. Field

Embodiments of the present invention relate to a display device capable of preventing or substantially preventing detachment between a window and a display panel at a high temperature.

2. Description of the Related Art

Electronic devices that provide images to users, such as smart phones, digital cameras, laptop computers, navigation units, and televisions, include display devices for displaying images. Each display device includes a display panel for displaying images, and a window on the display panel to protect the display panel, the display panel and the window being attached to each other by an adhesive layer.

The display panel may be a self-emission-type display panel, such as an organic light emitting diode (“OLED”) display panel, or may be a non-emission type display panel, such as a liquid crystal display (“LCD”) panel, an electro-phoretic display panel, an electro-wetting display panel, and/or the like.

It is to be understood that this background section is intended to provide useful background for understanding the technology and, as such, the background section may include ideas, concepts, or recognitions that are not part of the prior art.

### SUMMARY

Embodiments of the present invention are directed to a display device capable of preventing detachment between a window and a display panel.

According to an exemplary embodiment of the present invention, a display device includes: a display panel configured to display an image; a window on the display panel, the window including a display area configured to allow transmission of the image and a non-display area around the display area; and an adhesive layer between the display panel and the window. The window includes: a window substrate; a light blocking layer in the non-display area on the window substrate and facing the display panel; and an auxiliary adhesive layer on the light blocking layer.

The auxiliary adhesive layer may include a photocurable acrylate oligomer, a photocurable acrylate monomer, a rubber-based polymer, a photoinitiator, and a silane coupling agent.

The auxiliary adhesive layer may include: the photocurable acrylate oligomer in an amount of about 20 percent by weight (wt %) to about 40 wt %; the photocurable acrylate monomer in an amount of about 10 wt % to about 35 wt %; the rubber-based polymer in an amount of about 15 wt % to about 35 wt %; the photoinitiator in an amount of about 0.1 wt % to about 5 wt %; and the silane coupling agent in an amount of about 1 wt % to about 10 wt %.

The photocurable acrylate oligomer may comprise at least one of urethane (meth) acrylate oligomer, ester (meth) acrylate oligomer, ether (meth) acrylate oligomer, and epoxy (meth) acrylate oligomer.

The photocurable acrylate oligomer may have a weight-average molecular weight (Mw) ranging from about 5,000 to about 15,000.

The photocurable acrylate monomer may comprise at least one of isobornyl (meth) acrylate, lauryl (meth) acrylate, 4-hydroxybutyl (meth) acrylate, tetrahydro-furyl (meth) acrylate, and n-octyl (meth) acrylate.

The rubber-based polymer may comprise at least one of polybutadiene, polyisoprene, polystyrene, and polychloroprene.

The rubber-based polymer may have a weight-average molecular weight (Mw) ranging from about 2,000 to about 6,000.

The photoinitiator may comprise at least one of 2,2-dimethoxy-1,2-diphenylethane-1-one, trimethylbenzoyl diphenylphosphine oxide, 1-hydroxycyclohexyl-benzophenone, 2-methyl-1-[4-(methylthio)phenyl]-2-morpholinopropan-1-one, ethyl-2,4,6-trimethylbenzoyl phenyl phosphinate, 2-hydroxy-2-methyl-1-phenyl-1-propanone, and diphenyl (2,4,6-trimethyl benzoyl) phosphine oxide.

The silane coupling agent may comprise at least one of vinyl trimethoxysilane, and 3-glycidyl propyl trimethoxysilane.

The auxiliary adhesive layer may contact the adhesive layer.

The light blocking layer may include a black matrix.

The display device may further include a polarizing layer on the display panel.

The foregoing is illustrative only, and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other features and aspects of the present disclosure of invention will be more clearly understood from the following detailed description taken in conjunction with the accompanying drawings, in which:

FIG. 1 is a perspective view illustrating a display device according to an exemplary embodiment;

FIG. 2 is a cross-sectional view taken along the line I-I′ of FIG. 1;

FIG. 3 is a cross-sectional view illustrating a configuration of a pixel of a display panel in the area A of FIG. 1;

FIG. 4 is a perspective view illustrating a display device according to another exemplary embodiment; and

FIG. 5 is a cross-sectional view taken along the line II-II′ of FIG. 4.

### DETAILED DESCRIPTION

Aspects and features of embodiments of the present invention and methods for achieving them will be made clear from the embodiments described in detail below with reference to the accompanying drawings. The present invention may, however, be embodied in many different forms and should not be construed as being limited to the embodiments set forth herein. Rather, these embodiments are provided so that this disclosure will be thorough and complete, and will fully convey the scope of the invention to those skilled in the art. The present invention is merely defined by the scope of the claims. Therefore, well-known constituent elements, operations and techniques may not be described in detail in the embodiments in order to prevent the embodiments of the present invention from being obscured. Like reference numerals refer to like elements (or components) throughout the specification.

It will be understood that, although the terms “first”, “second”, “third”, etc., may be used herein to describe various elements, components, regions, layers, and/or sections, these elements, components, regions, layers and/or sections should not be limited by these terms. These terms are used to distinguish one element, component, region, layer or section from another element, component, region, layer or section. Thus, a first element, component, region, layer, or section discussed below could be termed a second element, component, region, layer, or section, without departing from the spirit and scope of the present invention.

The spatially relative terms “below”, “beneath”, “lower”, “under”, “above”, “upper”, and the like, may be used herein for ease of description to describe the relations between one element or component and another element(s) or component(s) as illustrated in the drawings. It will be understood that the spatially relative terms are intended to encompass different orientations of the device in use or operation, in addition to the orientation depicted in the drawings. For example, in the case in which a device shown in the drawing is turned over, the element positioned “below”, “beneath”, or “under” other elements or features may be placed “above” the other elements or features. Accordingly, the illustrative term “below” or “under” may include both the lower and upper positions. The device may also be oriented in the other direction, and thus the spatially relative terms may be interpreted differently depending on the orientations.

Further, it will also be understood that when one element, component, region, layer and/or section is referred to as being “between” two elements, components, regions, layers, and/or sections, it can be the only element, component, region, layer and/or section between the two elements, components, regions, layers, and/or sections, or one or more intervening elements, components, regions, layers, and/or sections may also be present.

As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the present invention refers to “one or more embodiments of the present invention.” Also, the term “exemplary” is intended to refer to an example or illustration.

The terminology used herein is for the purpose of describing particular example embodiments only and is not intended to be limiting. As used herein, the singular forms “a” and “an” are intended to include the plural forms as well, unless the context clearly indicates otherwise. It will be further understood that the terms “comprise,” “comprises,” “comprising,” “includes,” “including,” and “include,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on,” “connected to,” “coupled to,” “connected with,” “coupled with,” or “adjacent to” another element or layer, it can be “directly on,” “directly connected to,” “directly coupled to,” “directly connected with,” “directly coupled with,” or “directly adjacent to” the other element or layer, or one or more intervening elements or layers may be present. Further “connection,” “connected,” etc. may also refer to “electrical connection,” “electrically connect,” etc. depending on the context in which they are used as those skilled in the art would appreciate. When an element or layer is referred to as being “directly on,” “directly connected to,” “directly coupled to,” “directly connected with,” “directly coupled with,” or “immediately adjacent to” another element or layer, there are no intervening elements or layers present.

As used herein, the term “substantially,” “about,” and similar terms are used as terms of approximation and not as terms of degree, and are intended to account for the inherent deviations in measured or calculated values that would be recognized by those of ordinary skill in the art.

As used herein, the terms “use,” “using,” and “used” may be considered synonymous with the terms “utilize,” “utilizing,” and “utilized,” respectively.

Also, any numerical range recited herein is intended to include all sub-ranges of the same numerical precision subsumed within the recited range. For example, a range of “1.0 to 10.0” or between “1.0 and 10.0” are intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include ail higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. §112, first paragraph, and 35 U.S.C. §132(a).

Unless otherwise defined, all terms used herein (including technical and scientific terms) have the same meaning as commonly understood by those skilled in the art to which this invention pertains. It will be further understood that terms, such as those defined in commonly used dictionaries, should be interpreted as having a meaning that is consistent with their meaning in the context of the relevant art and will not be interpreted in an ideal or excessively formal sense unless clearly defined in the present specification.

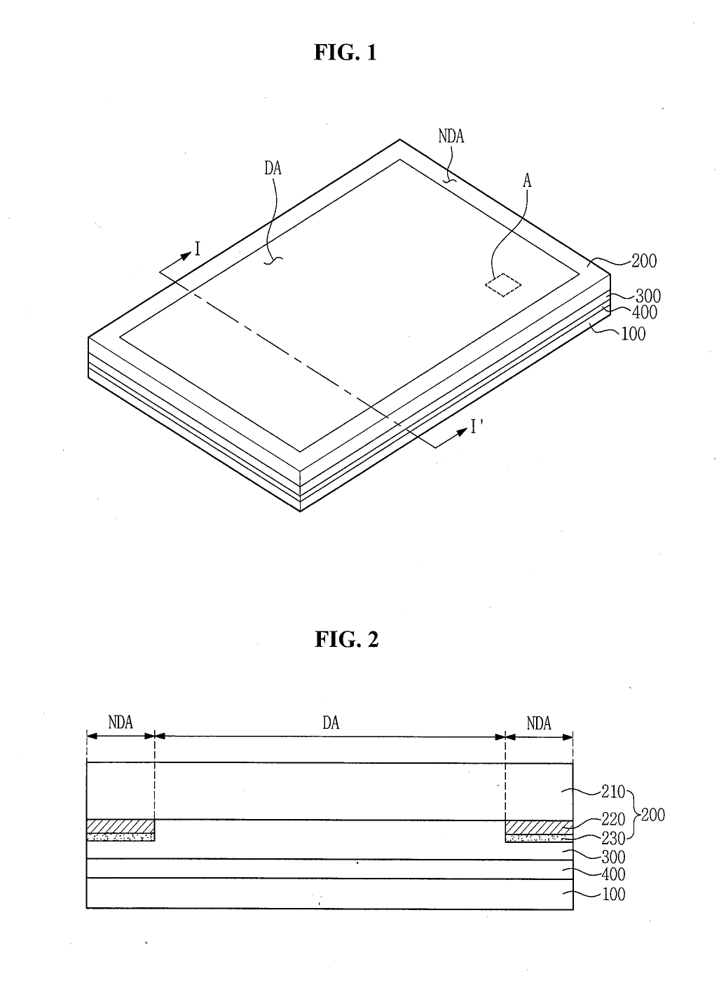

FIG. 1 is a perspective view illustrating a display device according to an exemplary embodiment; and FIG. 2 is a cross-sectional view taken along the line I-I′ of FIG. 1.

In reference to FIGS. 1 and 2, a display device according to an exemplary embodiment includes a display panel 100, a window 200 on the display panel 100, and an adhesive layer 300 between the display panel 100 and the window 200.

The display panel 100 generates an image, and the image generated in the display panel 100 is transmitted through the window 200 to be provided to a user.

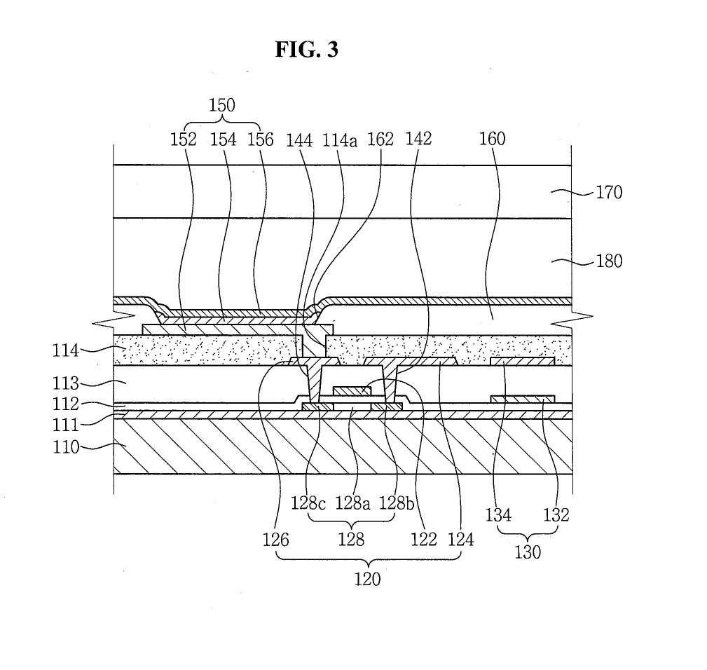

The display panel 100 may be a self-emission-type display panel, such as an organic light emitting diode (“OLED”) display panel, or may be a non-emission-type display panel, such as a liquid crystal display (“LCD”) panel, an electro-phoretic display panel, an electro-wetting display panel, and/or the like. Detailed descriptions with regard to the display panel 100 are to be provided hereinafter with reference to FIG. 3.

The window 200 includes a display area DA through which the image generated in the display panel 100 is transmitted, and a non-display area NDA around the display area DA. The window 200 is on the display panel 100 to protect the display panel 100 from external impacts.

The window 200 includes a window substrate 210, a light blocking layer 220 on a surface of the window substrate 210, and an auxiliary adhesive layer 230 on the light blocking layer 220.

The window substrate 210 faces the display panel 100, and the window substrate 210 may be a transparent glass substrate or a transparent plastic substrate.

The window substrate 210 may be quadrangular in shape, and may have a size substantially the same as a size of the display panel 100. However, the present invention is not limited thereto, and the window substrate 210 may have various suitable shapes, including a shape having a round corner portion, a shape having a curved corner portion, and so forth.

The light blocking layer 220 is on a surface of the window substrate 210 facing the display panel 100 in the non-display area NDA. The light blocking layer 220 may prevent or substantially prevent a driver, which is for driving the display panel 100, or an accommodating unit, which is for accommodating the display panel 100, from being externally visible.

The light blocking layer 220 may have various suitable colors including a black color or a white color. When having a black color, the light blocking layer 220 may include a black matrix. When having a white color, the light blocking layer 220 may include an organic insulating material, such as a white resin. Further, the light blocking layer 220 may include an opaque inorganic insulating material such as CrOₓ and MoOₓ, or an opaque organic insulating material such as a black resin.

The light blocking layer 220 may have a monolayer structure having a uniform thickness, but the present invention is not limited thereto. In some embodiments, the light blocking layer 220 may have a multilayer structure in which each layer has the same or substantially the same thickness, or may have a multilayer structure in which respective layers have different thicknesses.

The auxiliary adhesive layer 230 is on the light blocking layer 220 in the non-display area NDA, and the auxiliary adhesive layer 230 contacts the adhesive layer 300. The auxiliary adhesive layer 230 forms a covalent bond with a material forming the light blocking layer 220 and with a material forming the adhesive layer 300, thus enhancing interfacial bonding force between the light blocking layer 220 and the adhesive layer 300.

The auxiliary adhesive layer 230 may include a photocurable acrylate oligomer, a photocurable acrylate monomer, a rubber-based polymer, a photoinitiator, and/or a silane coupling agent.

More particularly, the auxiliary adhesive layer 230 may include the photocurable acrylate oligomer in an amount of about 20 wt % to about 40 wt %, the photocurable acrylate monomer in an amount of about 10 wt % to about 35 wt %, the rubber-based polymer in an amount of about 15 wt % to about 35 wt %, the photoinitiator in an amount of about 0.1 wt % to about 5 wt %, and the silane coupling agent in an amount of about 1 wt % to about 10 wt %.

The photocurable acrylate oligomer is cured by light, such as ultraviolet (UV) light, and may impart a cohesive force for an interfacial bonding between the light blocking layer 220 and the adhesive layer 300.

The photocurable acrylate oligomer may comprise at least one of the following: urethane (meth) acrylate oligomer such as a reactant material of polyisocyanate having two or more isocyanate groups in the molecule and hydroxyalkyl (meth) acrylate; ester (meth) acrylate oligomer such as a dehydration-condensation reactant material between polyester polyol and (meth) acrylate acid; ether (meth) acrylate oligomer such as polyalkylene glycol di (meth) acrylate; and epoxy (meth) acrylate oligomer such as an additive reactant material between an epoxy resin and (meth) acrylic acid. As used herein, the term “(meth) acrylate” refers to either acrylate or methacrylate.

In addition, the photocurable acrylate oligomer may have a weight-average molecular weight (Mw) ranging from about 5,000 to about 15,000.

The photocurable acrylate monomer may serve to decrease the viscosity of the auxiliary adhesive layer 230 to allow the auxiliary adhesive layer 230 to be readily coated on the light blocking layer 220.

The photocurable acrylate monomer may comprise at least one of isobornyl (meth) acrylate, lauryl (meth) acrylate, 4-hydroxybutyl (meth) acrylate, tetrahydro-furyl (meth) acrylate, n-octyl (meth) acrylate, and a mixture thereof. More particularly, the photocurable acrylate monomer may be a mixture of isobornyl (meth) acrylate, lauryl (meth) acrylate, 4-hydroxybutyl (meth) acrylate, tetrahydro-furyl (meth) acrylate, and n-octyl (meth) acrylate. However, a material forming the photocurable acrylate monomer is not limited thereto, and the photocurable acrylate monomer may include various suitable materials having a reactive functional group such as a (meth) acryloyl group.

The rubber-based polymer may serve to impart flexibility to the auxiliary adhesive layer 230.

The rubber-based polymer may comprise at least one of polybutadiene, polyisoprene, polystyrene, and polychloroprene. However, a material forming the rubber-based polymer is not limited thereto, and the rubber-based polymer may include various suitable materials known in the pertinent art.

In addition, the rubber-based polymer may have a weight-average molecular weight (Mw) ranging from about 2,000 to about 6,000.

The photoinitiator is excited by light so as to serve to initiate photocuring.

The photoinitiator may comprise at least one of 2,2-dimethoxy-1,2-diphenylethane-1-one, trimethylbenzoyl diphenylphosphine oxide, 1-hydroxycyclohexyl-benzophenone, 2-methyl-1-[4-(methylthio)phenyl]-2-morpholino propanone-1-one, ethyl-2,4,6-trimethylbenzoyl phenyl phosphinate, 2-hydroxy-2-methyl-1-phenyl-1-propanone, and diphenyl (2,4,6-trimethylbenzoyl) phosphine oxide. However, a material forming the photoinitiator is not limited thereto, and the photoinitiator may include various suitable materials known in the pertinent art.

The silane coupling agent may comprise at least one of vinyl trimethoxysilane, and 3-glycidyl propyl trimethoxysilane, and the silane coupling agent may form a covalent bond with a material forming the light blocking layer 220 and a material forming the adhesive layer 300.

The adhesive layer 300 may be a resin, such as a photocurable resin. In a case in which a photoinitiator included in the resin in a small amount is irradiated to light, for example, UV light, a photopolymerization reaction is initiated so that a monomer and an oligomer, which are primary elements (or components) of the resin, may quickly or instantaneously form a polymer to be cured.

The polarizing layer 400 is on the display panel 100. For example, the polarizing layer 400 may be between the display panel 100 and the adhesive layer 300. The polarizing layer 400 may convert an optical axis of light irradiated from the display panel 100.

The polarizing layer 400 may be formed into a size substantially the same as the size of the display panel 100 to cover the display panel 100. The polarizing layer 400 may have a monolayer structure, or may have a multilayer structure including a polarization film and a phase retardation film.

In a typical display device, a window is attached to a display panel or to a polarizing layer by an adhesive layer, and a light blocking layer on a window substrate contacts the adhesive layer. In this case, adhesion between the light blocking layer and the adhesive layer is significantly lower than adhesion between the window substrate and the adhesive layer, because surface roughness of the light blocking layer is significantly greater than surface roughness of the window substrate.

In particular, the adhesive layer contacting the light blocking layer may be detached from the adhesive layer at a high temperature due to low adhesion between the light blocking layer and the adhesive layer, and due to contraction of the polarizing layer, and the adhesive layer contacting the light blocking layer may contract. Accordingly, in the typical display device, detachment may occur between the window and the display panel at a high temperature.

In the display device according to the present invention, the auxiliary adhesive layer 230 contacting the adhesive layer 300 is on the light blocking layer 220, such that adhesion between the light blocking layer 220 and the adhesive layer 300 is enhanced, and such that detachment, which may otherwise occur between the display panel 100 and the window 200 at a high temperature, may be prevented or substantially prevented. In particular, the auxiliary adhesive layer 230 includes a silane coupling agent that forms a covalent bond with the material forming the light blocking layer 220 and the material forming the adhesive layer 300, such that adhesion between the light blocking layer 220 and the adhesive layer 300 may be enhanced.

FIG. 3 is a cross-sectional view illustrating a configuration of a pixel of the display panel 100 in the area A of FIG. 1. In the display device according to an exemplary embodiment, the display panel 100 is described as an OLED display panel by way of example.

In reference to FIG. 3, the first substrate 110 includes an insulating substrate including a material selected from the group consisting of: glass, quartz, ceramic, and plastic. However, an exemplary embodiment is not limited thereto, and the first substrate 110 may include a metal substrate including or being formed of stainless steel and/or the like.

A buffer layer 111 is on the first substrate 110. The buffer layer 111 may serve to reduce or effectively prevent infiltration of undesired elements, and may also planarize a surface of the first substrate 110. The buffer layer 111 may include, or may be formed of, at least one material selected from the group consisting of: silicon nitride (SiNₓ), silicon oxide (SiO₂), and/or silicon oxynitride (SiOₓN_{y}). However, the buffer layer 111 is not necessary, and may be omitted in consideration of the kinds and process conditions of the first substrate 110.

A semiconductor layer 128 is on the buffer layer 111. The semiconductor layer 128 may include at least one semiconductor material selected from the group consisting of polycrystalline silicon, amorphous silicon, and oxide semiconductors such as indium-gallium-zinc oxide (IGZO) and/or indium-zinc-tin oxide (IZTO). For example, in a case in which the semiconductor layer 128 is a polycrystalline silicon layer, the semiconductor layer 128 includes a channel region 128a that is not doped with impurities, and includes p+ doped source and drain regions 128b and 128c that are formed on respective sides of the channel region 128a. In this case, p-type impurities, such as boron B, may be used as a dopant ion, and in particular, B₂H₆ may be used. Such impurities may vary depending on the kind of thin film transistor (TFT).

A gate insulating layer 112 is disposed on the semiconductor layer 128. The gate insulating layer 112 includes, or is formed of, at least one selected from the group consisting of: tetraethylorthosilicate (TEOS), silicon nitride (SiNₓ), and/or silicon oxide (SiO₂). In some embodiments, the gate insulating layer 112 may have a double-layer structure in which a SiNₓ layer having a thickness of about 40 nm, and a TEOS layer having a thickness of 80 nm, are sequentially stacked. However, the gate insulating layer 112 is not limited to the aforementioned configuration, and may have various suitable structures.

A gate wiring is on the gate insulating layer 112. In this case, the gate wiring includes a gate line, a gate electrode 122, a first storage electrode 132, and additional wirings. In addition, the gate electrode 122 overlaps at least a portion of the semiconductor layer 128. For example, the gate electrode 122 may overlap the channel region 128a. The gate electrode 122 may serve to prevent or substantially prevent the channel region 128a from being doped with impurities when the source and drain regions 128b and 128c of the driving semiconductor layer 128 are doped with the impurities in the forming of the driving semiconductor layer 128.

The first storage electrode 132 and the gate electrode 122 are formed on the same layer, and include substantially the same metal material. In this case, the metal material may include at least one of molybdenum (Mo), chromium (Cr), and tungsten (W). In some embodiments, the gate electrode 122 and the first storage electrode 132 may include molybdenum (Mo) or molybdenum alloys.

The interlayer insulating layer 113 is on the gate insulating layer 112 to cover the gate electrode 122. The gate insulating layer 112 and the interlayer insulating layer 113 collectively define a source contact hole 142 exposing the source region 128b of the semiconductor layer 128, and a drain contact hole 144 exposing the drain region 128c of the semiconductor layer 128. The interlayer insulating layer 113 may include, or may be formed of, tetraethyl orthosilicate (TEOS), silicon nitride (SiNₓ), silicon oxide (SiO₂), and/or the like, in a manner similar to that of the gate insulating layer 112. However, the material forming the interlayer insulating layer 113 is not limited thereto.

A data wiring is disposed on the interlayer insulating layer 113. The data wiring includes a data line, a common power line, a second storage electrode 134, and additional wirings. The source electrode 124 and the drain electrode 126 are connected to the source region 128b and the drain region 128c of the semiconductor layer 128, respectively, through the respective contact holes 142 and 144.

As such, a thin film transistor (“TFT”) 120 includes the gate electrode 122, the source electrode 124, the drain electrode 126, and the semiconductor layer 128. The TFT 120 may have a p-type metal-oxide semiconductor (PMOS) structure using p-type impurities. However, the type of the TFT 120 is not limited thereto, and the TFT 120 may have an n-type metal-oxide semiconductor (NMOS) structure, or may have a complementary metal-oxide semiconductor (CMOS) structure. In addition, the TFT 120 may be a polycrystalline TFT, an amorphous TFT including an amorphous silicon layer, or an oxide semiconductor TFT.

In addition, the first storage electrode 132 and the second storage electrode 134 collectively form a capacitor 130. In such an embodiment, the interlayer insulating layer 113 is a dielectric body of the capacitor 130.

A planarization layer 114 is disposed on the interlayer insulating layer 113 to cover the data wiring. The planarization layer 114 is configured to remove a step difference and to planarize a surface therebelow to thereby improve light emission efficiency of an OLED 150, to be described below. Further, the planarization layer 114 has a pixel electrode contact hole 114a for exposing a portion of the drain electrode 126.

The planarization layer 114 may include, or may be formed of, at least one selected from the group consisting of: a polyacrylate resin, an epoxy resin, a phenolic resin, a polyamide resin, a polyimide resin, an unsaturated polyester resin, a poly-phenylenether resin, a poly-phenylenesulfide resin, and/or benzocyclobutene (BCB).

A pixel electrode 152 is on the planarization layer 114, and the pixel electrode 152 may be an anode electrode. The pixel electrode 152 is connected to the drain electrode 126 through the contact hole 114a in the planarization layer 114.

In addition, a pixel defining layer 160 is disposed on the planarization layer 114, and the pixel defining layer 160 has an aperture 162 to expose the pixel electrode 152. For example, the pixel electrode 152 corresponds to the aperture 162 of the pixel defining layer 160. The pixel defining layer 160 may include, or may be formed of, a resin, such as a polyacrylate resin and/or a polyimide resin.

An organic light emitting layer 154 is on the pixel electrode 152 in the aperture 162 of the pixel defining layer 160, and a common electrode 156 is on the pixel defining layer 160 and the organic light emitting layer 154.

As such, the OLED 150 includes the pixel electrode 152, the organic light emitting layer 154, and the common electrode 156.

One of the pixel electrode 152 and the common electrode 156 may be formed of a transparent conductive material, and the other thereof may be formed of a transflective conductive material or a reflective conductive material. Depending on the material forming the pixel electrode 152 and the common electrode 156, the OLED display device may become a top-emission type, a bottom-emission type, or a dual-emission type.

For example, the transparent conductive material may be at least one selected from the group consisting of: indium tin oxides (ITO), indium zinc oxides (IZO), zinc oxide (ZnO), and/or indium oxide (In₂O₃). The reflective material may be at least one selected from the group consisting of: lithium (Li), calcium (Ca), lithium fluoride/calcium (LiF/Ca), lithium fluoride/aluminum (LiF/Al), aluminum (Al), silver (Ag), magnesium (Mg), and/or gold (Au).

The organic light emitting layer 154 may be formed of a low molecular weight organic material or a high molecular weight organic material. The organic light emitting layer 154 may have a multilayer structure including at least one of a hole injection layer (“HIL”), a hole transporting layer (“HTL”), a light emitting layer, an electron transporting layer (“ETL”), and/or an electron injection layer (“EIL”). For example, the HIL, the HTL, the light emitting layer, the ETL, and the EIL may be sequentially stacked on the pixel electrode 152.

A capping layer may further be disposed on the common electrode 156. The capping layer may protect the OLED 150, and may serve to allow the light generated in the organic light emitting layer 154 to be efficiently emitted externally.

The second substrate 170 faces the first substrate 110, and the second substrate 170 may be attached and sealed to the first substrate 110. A sealant may further seal the second substrate 170 and the first substrate 110, and a space may be secured between the first substrate 110 and the second substrate 170.

The second substrate 170 may include a transparent insulating substrate including one of glass, quartz, ceramic, and/or the like. However, an exemplary embodiment is not limited thereto, and the second substrate 170 may be an encapsulation member, and may have a thin film structure in which an organic layer and an inorganic layer are alternately stacked.

An air layer 180 may be in the space between the first substrate 110 and the second substrate 170, more particularly, in a space between the common electrode 156 and the second substrate 170. However, an exemplary embodiment is not limited thereto, and in lieu of the air layer 180, a filler formed of a polymer, which is an organic material, may be in the space between the common electrode 156 and the second substrate 170.

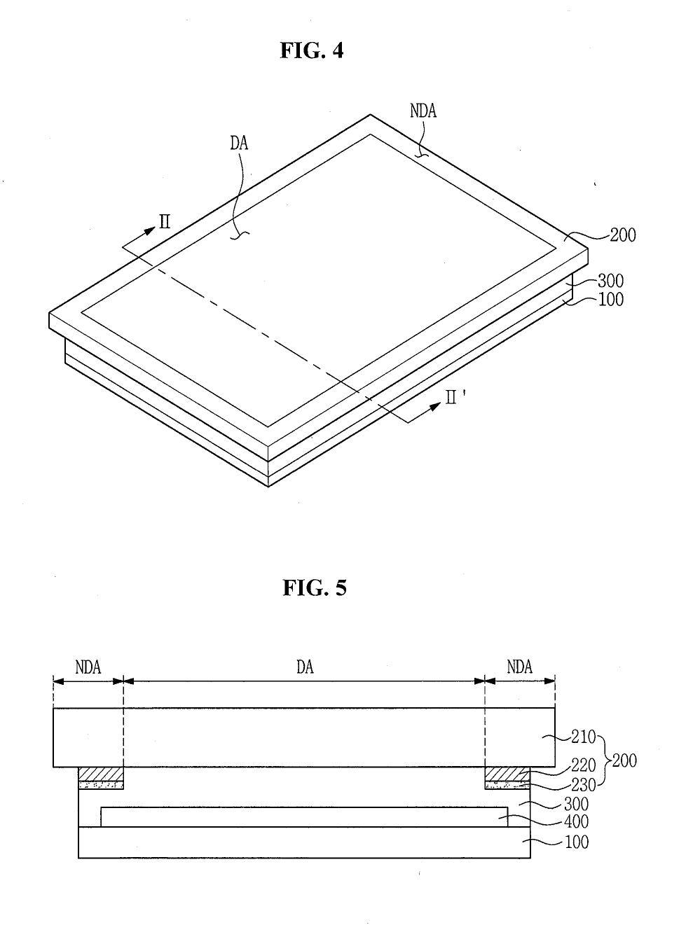

FIG. 4 is a perspective view illustrating a display device according to another exemplary embodiment, and FIG. 5 is a cross-sectional view taken along the line II-II′ of FIG. 4.

In reference to FIGS. 4 and 5, the display device illustrated in FIG. 4 has the same or substantially the same configuration as that of the display device illustrated in FIG. 1, with the exception of a window 200 and a polarizing layer 400, and thus descriptions with respect to the repeated configuration may be omitted for brevity.

A window substrate 210 may be quadrangular in shape, and may have a size that is greater than a size of a display panel 100. However, the present invention is not limited thereto, and the window substrate 210 may have various suitable shapes, including a shape having a round corner portion, a shape having a curved corner portion, and so forth.

A light blocking layer 220 is on a surface of the window substrate 210 facing the display panel 100 in a non-display area NDA, and an auxiliary adhesive layer 230 is on at least a portion of the light blocking layer 220 in the non-display area NDA.

The polarizing layer 400 is on the display panel 100 to cover at least a portion of the display panel 100, and the polarizing layer 400 may have a monolayer structure or a multilayer structure including a polarization film and a phase retardation film.

As set forth above, adhesion between the light blocking layer and the adhesive layer is enhanced through the use of the auxiliary adhesive layer, such that detachment phenomenon occurring between the window and the display panel at a high temperature may be prevented or significantly reduced.

From the foregoing, it will be appreciated that various embodiments in accordance with the present disclosure have been described herein for purposes of illustration, and that various suitable modifications may be made without departing from the scope and spirit of the present invention. Accordingly, the various embodiments disclosed herein are not intended to be limiting of the true scope and spirit of the present invention. Various features of the above described and other embodiments can be mixed and matched in any manner, to produce further embodiments consistent with the invention. Thus, the present embodiments of the invention should be considered in all respects as illustrative and not restrictive, the scope of the invention to be indicated by the appended claims and their equivalents.

What is claimed is:

1. A display device comprising:
a display panel configured to display an image;
a window on the display panel, the window comprising a display area configured to allow transmission of the image, and a non-display area around the display area; and
an adhesive layer between the display panel and the window,
wherein the window comprises:
a window substrate;
a light blocking layer in the non-display area on the window substrate and facing the display panel; and
an auxiliary adhesive layer on the light blocking layer.

2. The display device of claim 1, wherein the auxiliary adhesive layer comprises:
a photocurable acrylate oligomer;
a photocurable acrylate monomer;
a rubber-based polymer;
a photoinitiator; and
a silane coupling agent.

3. The display device of claim 2, wherein the auxiliary adhesive layer comprises:
the photocurable acrylate oligomer in an amount of about 20 percent by weight (wt %) to about 40 wt %;
the photocurable acrylate monomer in an amount of about 10 wt % to about 35 wt %;
the rubber-based polymer in an amount of about 15 wt % to about 35 wt %;
the photoinitiator in an amount of about 0.1 wt % to about 5 wt %; and
the silane coupling agent in an amount of about 1 wt % to about 10 wt %.

4. The display device of claim 2, wherein the photocurable acrylate oligomer comprises at least one selected from urethane (meth) acrylate oligomer, ester (meth) acrylate oligomer, ether (meth) acrylate oligomer and epoxy (meth) acrylate oligomer.

5. The display device of claim 4, wherein the photocurable acrylate oligomer has a weight-average molecular weight (Mw) ranging from about 5,000 to about 15,000.

6. The display device of claim 2, wherein the photocurable acrylate monomer comprises at least one selected from isobornyl (meth) acrylate, lauryl (meth) acrylate, 4-hydroxybutyl (meth) acrylate, tetrahydro-furyl (meth) acrylate, and n-octyl (meth) acrylate.

7. The display device of claim 2, wherein the rubber-based polymer comprises at least one selected from polybutadiene, polyisoprene, polystyrene, and polychloroprene.

8. The display device of claim 7, wherein the rubber-based polymer has a weight-average molecular weight (Mw) ranging from about 2,000 to about 6,000.

9. The display device of claim 2, wherein the photoinitiator comprises at least one selected from 2,2-dimethoxy-1,2-diphenylethane-1-one, trimethylbenzoyl diphenylphosphine oxide, 1-hydroxycyclohexyl-benzophenone, 2-methyl-1-[4-(methylthio)phenyl]-2-morpholinopropan-1-one, ethyl-2,4,6-trimethylbenzoyl phenyl phosphinate, 2-hydroxy-2-methyl-1-phenyl-1-propanone, and diphenyl (2,4,6-trimethyl benzoyl) phosphine oxide.

10. The display device of claim 2, wherein the silane coupling agent comprises at least one selected from vinyl trimethoxysilane, and 3-glycidyl propyl trimethoxysilane.

11. The display device of claim 1, wherein the auxiliary adhesive layer contacts the adhesive layer.

12. The display device of claim 1, wherein the light blocking layer comprises a black matrix.

13. The display device of claim 1, further comprising a polarizing layer on the display panel.
